(19) United States
(12) Patent Application Publication
(10) Pub. No.: US 2004/0009774 A1
(43) Pub. Date: Jan. 15, 2004

(54) Method and apparatus for extending cellular service to an isolated cell

(75) Inventors: Michael D. Kotzin, Buffalo Grove, IL (US); Stephen Spear, Skokie, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/191,857

(22) Filed: Jul. 9, 2002

(51) Int. Cl. H04Q 7/20

(52) U.S. Cl. 455/450; 455/444; 455/560; 455/561

(57) ABSTRACT

A remote base controller (20) communicates with a base site controller (22) as a macro cell, converts outbound macro cell traffic from the base site controller (22) into outbound isolated cell traffic, inbound isolated cell traffic into inbound macro cell traffic, and communicates, via a cable head end (18) establishing an internet protocol internet connection with a customer premise equipment (16), with a remote base (14) that provides cellular service to a mobile telephone (12) located within an isolated cell (2).

### FIELD OF THE INVENTION

The present invention relates generally to cellular systems and more specifically to a method and apparatus for extending cellular service to isolated areas with limited coverage.

### BACKGROUND OF THE INVENTION

Conventional cellular systems provide access to the public switched telephone network (PSTN) for subscriber units, such as cellular handsets or mobiles. To obtain service a cellular handset communicates with a base transmitter or transceiver station (BTS), which is coupled to a mobile switching center (MSC), normally via a base site controller (BSC), that is subsequently coupled to the PSTN. If a subscriber unit is in an area of poor coverage, it will be unable to communicate with the BTS and hence unable to obtain service or only able to obtain degraded service. Also, It may be desirable to provide to the user a more local “short range service” that can be provided at a lower tariff since it does not utilize the “wide area coverage” resources of the system.

A common area of poor coverage or an area in which it is desired to provide the local short-range service is often the home of a user. One way to improve cellular coverage in the home or not use costly wide area coverage resources of the system is for the service provider to install a BTS in the home. However, such a task would be economically impractical due to the high costs of a BTS and the recurring backhaul costs of coupling a conventional BTS to a BSC (typically a T1 or E1 trunk).

Therefore, what is needed is an apparatus and method for extending cellular coverage to isolated areas with poor coverage without incurring undue costs and without adversely affecting cellular system capacity. It would be advantageous for such an apparatus and method to utilize existing communication protocols and authentication and authorization techniques.

### BRIEF DESCRIPTION OF THE DRAWINGS

Objects and advantages of the present invention will be more readily apparent from the following detailed description of the preferred embodiments thereof when taken together with the accompanying drawings in which:

FIG. 1 is an exemplary view of a system architecture according to the present invention;

FIG. 2 is an exemplary view of the logical channel mapping according to the present invention;

FIG. 3 is a flow diagram of the methodology by which cellular service is established according to the present invention when a subscriber device originates a registration request; and

FIG. 4 is a flow diagram of the methodology by which cellular service is established when a call is received at a subscriber device according to the present invention

### DETAILED DESCRIPTION OF THE PREFERRED EMBODIMENTS

The instant disclosure is provided to further explain in an enabling fashion the best modes of performing the embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software will be limited in the interest of brevity and minimization of any risk of obscuring the principles and concepts according to the present invention.

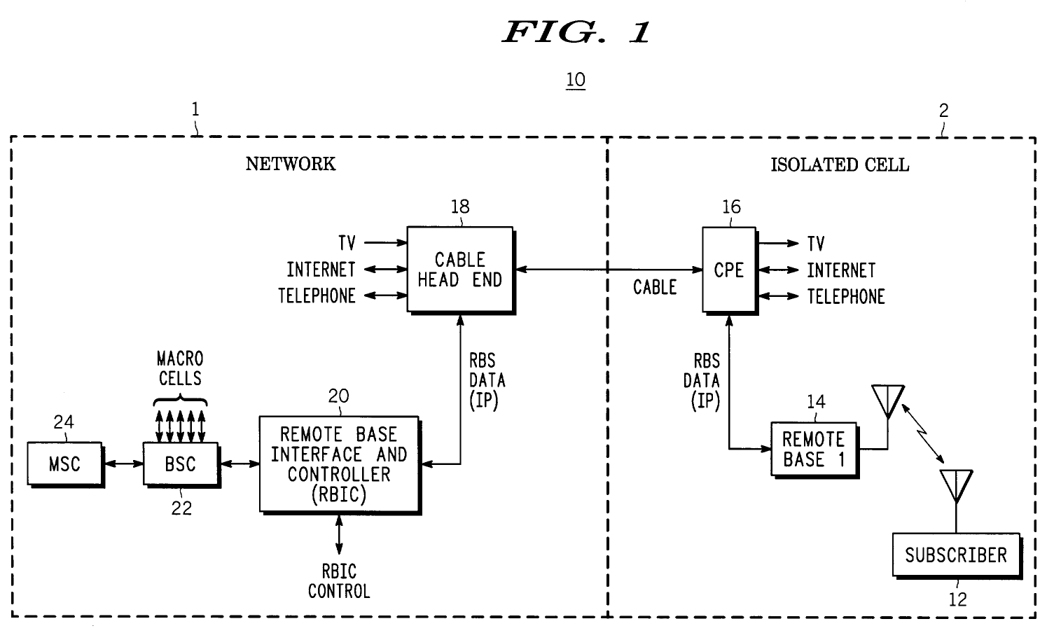

Referring now to the drawings in which like numerals reference like parts, FIG. 1 shows an exemplary system (system) 10 in which one or more of the preferred embodiments according to the present invention is advantageously deployed. The system includes a network zone 1 and an isolated cell 2. One isolated cell 2 is shown for illustrative purposes. However, a plurality of isolated cells 2 can be utilized and are intended to be within the scope of the present invention. Therefore, the isolated cell 2 can represent a plurality of isolated cells 2. The network zone 1 and the isolated cell 2 will be discussed in detail below.

Each of the isolated cells 2 is preferably an area of limited cellular coverage such as the home of a subscriber. Each isolated cell 2 includes one or more subscriber devices such as a cellular handset, mobile telephone, or the like (hereafter “mobile telephone” or “subscriber device”) 12, a remote base 14 and customer premise equipment (CPE) such as a digital subscriber line (DSL) modem or set top box 16. The remote base 14 is arranged and constructed to and for providing cellular service within the isolated cell 2. The remote base 14 provides a control channel and one or more traffic channel(s) for the subscriber device 12 or a plurality of subscriber devices. Hereinafter the discussion and description will refer to subscriber device or mobile telephone in the singular but it will be appreciated that multiple such devices could be supported provided the balance of the system of FIG. 1 is properly configured. More specifically, the subscriber device 12 obtains cellular service by searching or scanning for and receiving or obtaining the control channel broadcasted by the remote base 14. As one of ordinary skill in the art will understand, the remote base 14 is similar to an ordinary base transceiver station (BTS) (not depicted) used in most or all cellular systems with the addition of means, such as a cable link or the like, for connecting the remote base 14 to the CPE 16, preferably via an internet protocol (IP) connection. From the subscriber device or mobile telephone's perspective the remote base 14 is functionally identical to a BTS. The remote base 14, preferably, maintains a single carrier that supports a control channel and at least one but possibly more traffic channels. The CPE 16 provides an always-on internet connection via, for example, a cable internet connection. However, such an always-on internet connection may be obtained by other equivalent means such as a DSL modem. The CPE may also provide cable television, internet connectivity, and land based telephone service. While the CPE 16, preferably, has a cable connection with the remote base 14, this connection may be made using wireless means, such as an 802.11(a) based wireless link. The CPE 16 and the remote base 14 exchange data (RBS data) via an internet protocol (IP) connection. Each isolated cell 2 includes one remote base 14. The term, remote bases 14, will be use to describe the remote base 14 in each of the isolated cells 2.

The network zone 1 includes a cable head end 18 or equivalent digital subscriber line device having a wired or terrestrial connection to one or more of a cable television provider, an internet service provider and a land-based telephone service provider in addition to an IP based connection to a remote base interface and controller (RBIC) 20 (alternatively referred to as a remote base controller). The cable head end 18 thus facilitates and provides an IP connection between the RBIC 20 and each of the isolated cells 2. The RBIC 20 is coupled, typically via a T1 or E1 trunk line (hereinafter a T1 line) to a cellular telephone system including one or more base site controller(s) (BSC) 22 (one depicted), each of which is connected to a mobile switching center (MSC) 24 and from there to the PSTN or other terrestrial base wide area network (WAN) (not shown). The BSC 22 communicates with and controls a plurality of base transmitter or transceiver stations (BTSs) providing service to disparate macro cells and communicates with and controls the RBIC 20 as though it were a BTS. From the perspective of the BSC 22 the RBIC 20 looks like any other macro cell or BTS serving a macro cell. The interface between the remote base 14 and RBIC 20 is transparent to the BSC 22. More specifically, the BSC 22 provides conventional control over the isolated cells 2 by providing outbound macrocell traffic via the T1 line to the RBIC 20, which converts the outbound macrocell traffic to isolated cell traffic. The RBIC 20 also converts inbound isolated cell traffic into inbound macro cell traffic and sends the inbound macro cell traffic via the T1 line to the BSC 22. The RBIC 20 also receives or monitors data from the remote bases 14 and controls the remote bases 14. The RBIC 20 will be discussed in further detail below.

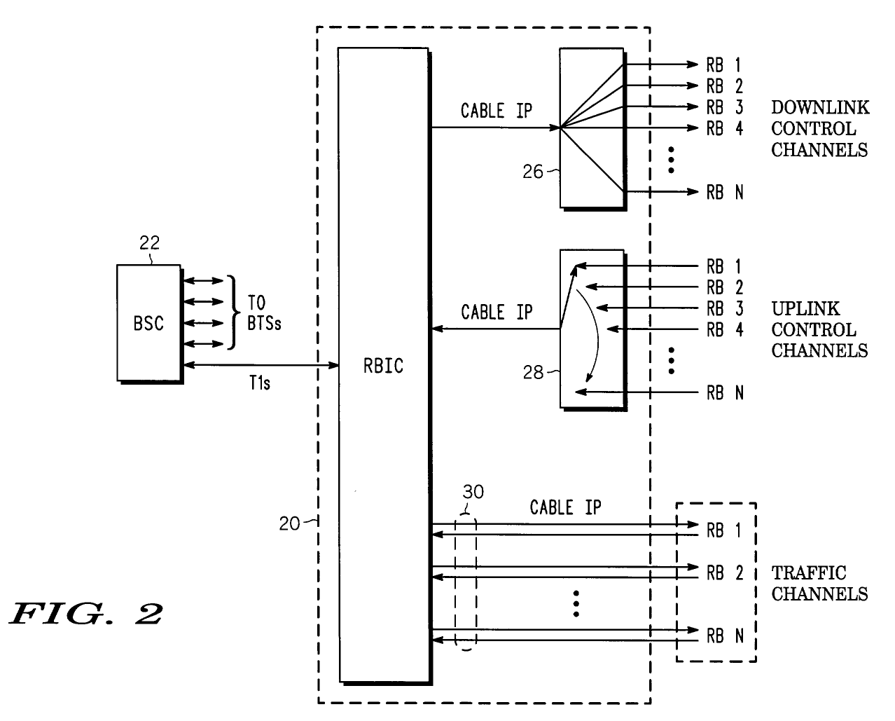

Referring to the logical signal mapping diagram of FIG. 2, the RBIC 20 includes what will be referred to as a distributor 26, a concentrator 28 and a plurality of dedicated transceivers 30 for terminating the channels depicted that exist at a logical level. The distributor 26 and the concentrator 28 are shared by all of the remote bases 14 under the control of this particular RBIC 20. The distributor 26 is for distributing to each remote base 12 (RB 1-RB N), outbound isolated cell traffic corresponding to control channel traffic. The outbound isolated cell traffic results from converting outbound macro cell traffic that was provided by the BSC 22 to the RBIC 20. More specifically, the distributor 26 provides or distributes a downlink control channel to each remote base 14. The RBIC converts broadcast messages received as macro cell traffic, specifically macro cell control channel traffic, from the BSC 22 to isolated cell control channel or broadcast messages (IP packets) and the distributor 26 distributes the messages to the remote bases 14. This can use a known technique referred to as multicast where a given IP packet can have multiple destinations, etc. The broadcast messages include, for example, pages for a particular subscriber unit or remote base channel assignments received from the BSC 22 via the T1 line. Essentially in one embodiment all of the information on the downlink control channel is distributed to each remote base to be broadcast within each isolated cell.

The concentrator 28 is for concentrating inbound isolated cell control channel traffic from all of the remote bases 14 into one inbound macro cell control channel with inbound macro cell control channel traffic. More specifically, the concentrator 28 receives on uplink control channels registration requests and page responses from the remote bases 14. The concentrator 28 multiplexes or sequentially passes data received via each of the uplink control channels to the BSC 22 as though it were typical macrocell traffic. Basically uplink control channel data received from each of the remote bases as IP packets or messages is converted and multiplexed onto one uplink macro control channel and passed on or sent from the RBIC 20 to the BSC 22. The plurality of dedicated transceivers 30 are for sending the outbound isolated cell traffic that corresponds to payload or voice and data traffic for a specific subscriber unit to the remote bases 14 and for receiving the corresponding inbound isolated cell traffic from the remote bases 14. The plurality of dedicated transceivers 30 facilitate or provide a plurality of dedicated traffic channels between the RBIC 20 and the plurality of remote bases 14. More specifically, each of the transceivers 30 is in communication with a respective CPE 16 via an internet protocol address and thus connection specified by the respective CPE 16. Outbound isolated cell traffic is sent from/to one of the plurality of dedicated transceivers 30 to/from an internet protocol address identifying a specific CPE 16 and a remote base 14 to be sent over the air via a traffic channel. As will be more fully discussed below, the transceivers 30 map a channel assignment received from the BSC 22 to one of the plurality of remote bases 14.

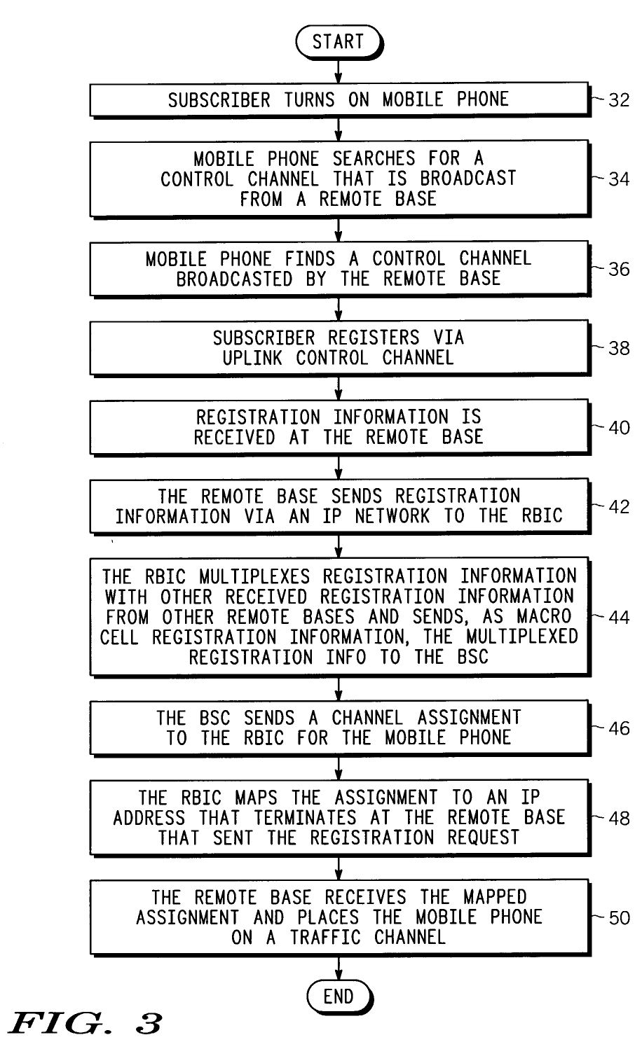

Referring now to the exemplary system 10 of FIG. 1 and the flow diagram of FIG. 3, a methodology for a subscriber device to originate a service request such as, for example, a registration request or call origination request will be discussed and described. The following discussions presume that the remote base 14 has established an IP connection, sometime referred to as a context, between the RBIC 20 and the remote base 14 or in other words the above discussed downlink and uplink control channels. At 32, a subscriber turns on a subscriber device, such as a mobile telephone 12, by, for example, activating a power switch (not shown). At 34, the mobile telephone 12 searches for a control channel that is broadcast from the remote base 14. At 36 the mobile telephone 12 locates or finds and receives this downlink or broadcast control channel.

At 38, the subscriber sends registration information via the uplink control channel to the remote base 14 and this is received at the remote base as shown by 40. At 42, the remote base 14 sends the uplink control channel registration information to the RBIC 20 via the IP connection. The physical link includes a hop from the remote base 14 to the CPE 16 via an IP connection and from there to the cable head end 18, which sends the registration information to the RBIC 20. At 44 the RBIC 20 via the concentrator 28 multiplexes the registration information with any other service requests data received from other remote bases 14 into a conventional single inbound or uplink macro cell control channel information stream. The RBIC 20 subsequently sends the registration information to the BSC 22 as macro cell traffic just like any other BTS serving other macro cells.

If the registration request also included a service request that required a traffic channel or channel assignment, 46 depicts, the BSC 22 sending a channel assignment for the mobile phone 12 as outbound macro cell traffic on the outbound control channel to the RBIC 20. Because the BSC 22 communicates with the RBIC 20 as if the RBIC 20 was a BTS, the channel assignment indicates a carrier and in TDM systems a time slot. However, the RBIC 20 does not have carriers. Rather, the RBIC 20 has the above discussed dedicated traffic channels. Therefore, at 48, the RBIC maps (distributes) the channel assignment to the remote base 14 that originated the service request. More specifically, the RBIC 22 determines which of the traffic channels at the remote base 14 are available and the IP address of the corresponding isolated cell 2 specified by the CPE 16 (corresponding to the remote base 14). The RBIC 22 then sends a broadcast message via the distributor 26 to all of the remote bases 14. This broadcast message is directed to the attention of the remote base 14 in communication with the mobile telephone 12 that initiated the service request and includes instructions as to which traffic channel for the mobile telephone 12 to use. Alternatively, the RBIC 22 could send the message only to the remote base 14 rather than broadcasting it if, for example, network bandwidth was limited. At 50, the remote base 14 receives the channel assignment and directs the mobile telephone 12 to the traffic channel specified by the RBIC 20.

The above methodology does not apply solely to registration requests. Other service requests, such as subscriber call origination, page response, feature activation, authentication or location update received are implemented in accordance with the above-described methodology.

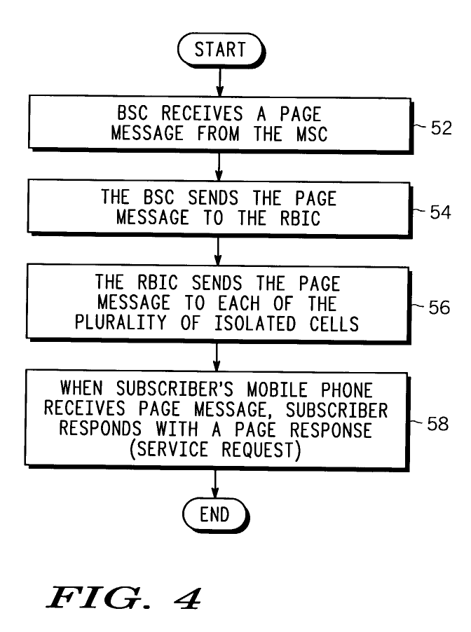

Referring now to FIG. 4, a methodology for a subscriber device to receive or terminate a call will be discussed. At 52, the BSC 22 receives a page from the MSC 24 indicating that the mobile telephone 12 has an incoming telephone call. At 54, the BSC 22 sends the page to the RBIC 20 via the T1 line. At 56, the distributor 26 of the RBIC 20 distributes the page to all of the remote bases 14 on the downlink control channels via the distributor 26. The remote bases 14 broadcast on their respective control channel the page message in search of the paged or specific mobile telephone 12. At 58, the mobile telephone 12, while monitoring the control channel receives the page. The mobile telephone then responds with a page response and the method for handling a service request described above and shown in FIG. 3 is followed to get a traffic channel assignment and complete the circuit or connection for the call.

Therefore, the present invention provides a system and method for providing or extending cellular service to areas of limited coverage (isolated cells 2) by providing a remote base 14 coupled to an established infrastructure for backhaul (such as the cable network), and a remote base interface controller 20 for communicating, via an internet connection, with the established infrastructure and thus the remote base 14. Further, the RBIC communicates and interfaces with a traditional cellular system infrastructure (such as a BSC 22) as any other BTS serving any other macro cell, and converts outbound macro cell traffic into outbound isolated cell traffic, and inbound isolated cell traffic into inbound macro cell traffic.

The structure and the methodology of the present invention provide numerous advantages. For example, utilizing an established internet connection for providing cellular service to the isolated cell 2 generally does not use limited cellular capacity and further reduces or eliminates the backhaul costs of extending a T1 connection to the isolated cell 2. Also, the system of the present invention is easier to deploy and more cost efficient because it takes advantage of internet capabilities that are widely available. In addition, the RBIC 20 of the present invention is transparent to the BSC 22. More specifically, because the BSC 22 communicates with the RBIC 20 as if it was a BTS, no modifications are needed at the BSC.

While the above description is of the preferred embodiment of the present invention, it should be appreciated that the invention may be modified, altered, or varied without deviating from the scope and fair meaning of the following claims.

For example, the distributor 26 could be modified to selectively send channel assignments to reduce bandwidth requirements due to broadcast messaging.

The RBIC 20 or the remote base 14 may be modified to place a test signal on an RF channel after sending or receiving a channel assignment to insure that the channel mapping is correct.

The RBIC 20 or the remote base 14 may be modified to handover cellular service to an artificial cell in order for the BSC to handle audio service if the remote base 14 lacks an available voice channel.

Also, the RBIC 20 could modify the traffic channel assignments for the plurality of remote bases to make all traffic channels on a slot adjacent to a control slot to account for time division multiple access communication systems.

1. A remote base controller comprising:
means for communicating with a cellular telephone system as a macro cell;
means for converting outbound macro cell traffic into outbound isolated cell traffic, and inbound isolated cell traffic into inbound macro cell traffic; and
means for communicating with a remote base providing cellular service to an isolated cell.

2. The remote base controller of claim 1, wherein the means for communicating with a remote base providing cellular service to an isolated cell is further for sending the outbound isolated cell traffic to the remote base.

3. The remote base controller of claim 1, wherein the means for communicating with a cellular system as a macro cell is further for receiving a channel assignment from the cellular system.

4. The remote base controller of claim 3, wherein the means for communicating with a remote base providing cellular service to an isolated cell is further for distributing the channel assignment to the remote base providing cellular service to the isolated cell.

5. The remote base controller of claim 4, wherein the means for communicating with a remote base providing cellular service to an isolated cell is further for mapping the channel assignment to an internet protocol address that terminates at the remote base.

6. The remote base controller of claim 4, wherein the means for communicating with a remote base providing cellular service to an isolated cell is further for mapping the channel assignment to a traffic channel at the remote base.

7. The remote base controller of claim 6, wherein the means for communicating with a remote base providing cellular service to an isolated cell is further for modifying a traffic channel assignment to make all traffic channels on a slot adjacent to a remote control slot.

8. The remote base controller of claim 1, wherein the means for communicating with a remote base providing cellular service to an isolated cell comprises an internet protocol connection.

9. The remote base controller of claim 1, wherein the means for communicating with a remote base providing cellular service to an isolated cell communicates via an internet protocol connection provided by one of a cable internet connection and a digital subscriber line internet connection.

10. The remote base controller of claim 1, wherein:
the means for communicating with a remote base providing cellular service to an isolated cell is further for communicating with a plurality of remote bases, each providing cellular service to a respective isolated cell; and
the means for communicating with a remote base providing cellular service to an isolated cell is further for selectively distributing a channel assignment received from the cellular telephone system to the remote base providing cellular service to the isolated cell

11. A method of extending cellular service to an isolated cell comprising:
receiving a subscriber service request from an isolated cell;
sending the subscriber service request to a cellular telephone system as a macro cell service request;
receiving a channel assignment from the cellular telephone system; and
distributing the channel assignment to the isolated cell.

12. The method of claim 11, wherein:
the receiving a subscriber service request from an isolated cell further comprises receiving a plurality of subscriber service requests from a plurality of isolated cells;
the sending the subscriber service request to a cellular telephone system as a macro cell service request further comprises multiplexing the plurality of subscriber service requests into a macro cell service request;
the receiving a channel assignment from the cellular telephone system further comprises receiving a plurality of channel assignments from the cellular telephone system for the plurality of isolated cells, respectively; and
the distributing the channel assignment to the isolated cell further comprises distributing the plurality of channel assignments to at least one of the plurality of isolated cells, respectively.

13. The method of claim 12, further comprising mapping each of the plurality of channel assignments to one of a plurality of internet protocol addresses that terminate at a respective isolated cell of the plurality of isolated cells prior to the distributing the plurality of channel assignments to at least one of the plurality of isolated cells, respectively.

14. The method of claim 12, wherein the receiving a plurality of subscriber service requests from a respective plurality of isolated cells further comprises receiving a plurality of subscriber service requests via an internet protocol connection.

15. The method of claim 14, wherein the receiving a plurality of subscriber service requests via an internet protocol connection further comprises receiving a plurality of subscriber service requests via an internet protocol provided by one of cable internet connection and a digital subscriber line internet connection.

16. The method of claim 12, further comprising:
receiving a page from the cellular telephone system; and
distributing the page to the plurality of isolated cells.

17. The method of claim 11, further comprising:
the receiving a subscriber service request from an isolated cell further comprises receiving one of a subscriber call origination, page response, feature activation, authentication or location update from a plurality of isolated cells; and
the sending the subscriber service request to a cellular telephone system as a macro cell service request further comprises sending one of the subscriber call origination, page response, feature activation, authentication or location update received from the plurality of isolated cells.

18. A system for extending cellular service to an isolated cell comprising:
a remote base coupled to an established internet connection for providing cellular service to an isolated cell; and
a remote base controller for communicating via the established internet connection with the remote base and communicating with a cellular system as a macro cell, for converting outbound macro cell traffic into outbound isolated cell traffic, and inbound isolated cell traffic into inbound macro cell traffic

19. The system of claim 18, wherein the established internet connection further comprises an internet protocol connection that is one of a cable internet connection and a digital subscriber line internet connection.

20. The system of claim 18, wherein the remote base controller comprises:
means for receiving service requests from a plurality of isolated cells;
means for sending pages to the plurality of isolated cells; and
means for mapping directly to the plurality of isolated cells.

21. The system of claim 20, wherein the remote base controller further comprises means for receiving a plurality of channel assignments for the plurality of isolated cells and means for distributing the plurality of channel assignments.

22. The system of claim 20, wherein the means for distributing the plurality of channel assignments is further for distributing one of the plurality of channel assignments to a channel assignment at one of the plurality of isolated cells.
